(19) United States
(12) Patent Application Publication
(10) Pub. No.: US 2006/0133957 A1
(43) Pub. Date: Jun. 22, 2006

(54) Device and method for fragmenting material by hydrodynamic shear

(76) Inventors: Merrill A. Knapp, Menlo Park, CA (US); Victor M. Aguero, Los Gatos, CA (US); Jose P. Joseph, Palo Alto, CA (US); Keith R. Laderoute, Palo Alto, CA (US); Richard P. Heydt, Palo Alto, CA (US); Rachel McCloskey, Santa Clara, CA (US)

Correspondence Address: PERKINS COIE LLP, P.O. BOX 2168, MENLO PARK, CA, 94026, US

(21) Appl. No.: 10/759,556

(22) Filed: Jan. 16, 2004

Related U.S. Application Data
(60) Provisional application No. 60/440,841, filed on Jan. 17, 2003.

(51) Int. Cl. B01L 3/00

(52) U.S. Cl. 422/72; 422/102

(57) ABSTRACT

A device and method for use with a centrifuge for fragmenting solute or particulate material contained in a liquid sample are disclosed. The device includes a substrate adapted to be supported within a centrifuge tube, and providing a microchannel defining a plurality of shear regions. Material contained in a liquid sample applied to the device, with such supported in a centrifuge tube within a centrifuge, is fragmented by shearing as the sample is forced successively through the plurality of shear regions in the microchannel, when the selected centrifugal force applied to the tube.

This application claims priority of U.S. Ser. No. 60/440,841 filed on Jan. 17, 2003, which is incorporated in its entirety herein by reference.

### FIELD OF THE INVENTION

This invention relates to a device and method for fragmenting material, such as large molecular weight polymers, cells, lipid particles and the like, by hydrodynamic shear.

### BACKGROUND OF THE INVENTION

Several methods have been described for fragmenting solute or particulate material contained in a liquid sample, for example, fragmenting DNA into smaller polynucleotide molecules for preparation of libraries and cloning for DNA sequence analysis, chromatin immunoprecipitation assay, and other biological research purposes.

Various fragmentation methods include passing the solution or suspension through a syringe or pipette, atomization, sonic treatment, and, in the case of DNA fragmentation, the use of restriction enzymes such as restriction endonucleases. While these methods have been successful in generating—DNA fragments, each method has limitations. The syringe method often fails to provide small enough fragments—for the study of DNA replication, repair, and transcription. It is also labor intensive and low throughput. Sonic treatment requires a large amount of sample material, generates a broad distribution of fragments, and is difficult to reproduce. Enzymatic methods requires a cocktail of different enzymes to generate the necessary fragments for proper sequence analysis; but do not produce random fragmentation. In addition, enzymatic methods often produce a broad distribution of fragments and a low yield of fragments of appropriate lengths for subsequent analysis.

Therefore, there exists a need in the art for an apparatus and method to efficiently produce a narrow and reproducible distribution of random fragments. There is also a need for a device and method that can efficiently extremely small sample volumes, preferably in a single pass, can be operated in a multiplexed (multi-sample) mode, and at the same time, is relatively inexpensive by virtue of utilizing existing laboratory equipment.

### SUMMARY OF THE INVENTION

The invention includes, in one embodiment, a device for use with a centrifuge for fragmenting solute or particulate material contained in a liquid sample. The device includes a substrate adapted to be supported within a centrifuge tube. A microchannel formed in the substrate and extending between upper and lower channel ends defines a plurality of shear regions, each designed to subject material present in the sample liquid to a shearing force as sample liquid is forced through the shear region under the influence of a selected centrifugal force applied to the tube in which the device is supported. The device may include a plurality of microchannels in the same substrate, with each microchannel having similar or dissimilar geometries, and each microchannel having a plurality of shear regions. Material contained in a liquid sample applied to the upper end of the microchannel, with the device supported in a centrifuge tube within a centrifuge, is fragmented by shearing as the sample is forced successively through the plurality of shear regions in the microchannel, when the selected centrifugal force applied to the tube.

In various embodiments, (i) the device further includes a holder adapted to be received within a selected-size centrifuge tube, and adapted to support the substrate within the tube; (ii) the substrate includes support members constructed to support the substrate within a selected-size centrifuge tube; and (iii) the device is formed as an integral unit with a centrifuge tube.

The microchannel preferably includes at least 5 shear regions, typically 10-20 or more. The microchannel may be serpentine in shape, for example, to increase the number of shear regions that can be accommodated along the flow path.

The device may include a sample-receiving well and a fluid-flow barrier interposed between the well and the microchannel, for preventing liquid sample applied to the well from reaching the upper end of the microchannel until a selected centrifugal force is applied to the device. The barrier may include a pair of deformable members that remain interlocked at a channel-sealing condition until deformed under the selected centrifugal force. Alternatively, the barrier may include a frangible seal designed to fracture when a liquid sample is forced against the seal under the selected centrifugal force. In still another embodiment, the barrier may include an electronically controlled valve that can be activated, from a closed to an open condition, when an external electronic signal is applied to the valve.

The shear regions in the microchannel may be defined by a change in the cross-sectional area of the channel, in a direction substantially perpendicular to the direction of fluid flow in the channel. For example, a shear region may be defined by adjacent upstream and downstream channel segments having a ratio of cross-sectional areas of at least 3:1. In this embodiment, the upstream channel segment includes a central barrier which acts to prevent liquid flow through a central portion of that channel segment. This embodiment is used, for example, in fragmenting polynucleotide molecules, where the downstream segment in a microchannel has a width dimension of less than 20 microns.

The shear regions in the microchannel may be defined by changes in the direction of liquid flow in the microchannel, that is, bends or curves in the microchannel that force sample liquid to change direction as it is forced through the microchannel. In still another embodiment, the shear regions may be defined by physical barriers or baffles placed in the path of liquid flow in the microchannel.

In a related aspect, the invention includes a polymer-fragmentation kit designed for use with a centrifuge for fragmenting a sample solution of polymers, such as polynucleotides, into a plurality of polymer-fragment pools, each with a different fragment-size range. The kit includes a plurality of fragmentation devices of the type described above, where the shear regions in each device have a device-specific shear-region geometry designed to subject material present in the sample solution of polymers to a device-specific shearing force as sample solution is forced through the shear region under the influence of a selected centrifugal force applied to the tube in which the device is supported. The polymers contained in a liquid sample applied to the upper ends of different devices in the kit, with the devices supported in centrifuge tubes within a centrifuge, are fragmented by shearing as the samples are forced successively through the plurality of shear regions in each device, to produce polymer fragments having different size ranges.

In still another aspect, the invention provides a method for use with a centrifuge for fragmenting solute or particulate material contained in a liquid sample. The method includes the steps of applying the sample solution to an upstream region of a microchannel device having a microchannel defining a plurality of shear regions, and with the microchannel device supported within a centrifuge tube in the centrifuge, subjecting the tube to the selected centrifugal force. Sample material is fragmented by shearing as the sample is forced successively through the plurality of shear regions in the microchannel.

The method may be used for processing a plurality of samples at the same time, by applying one or more sample solutions to each of a plurality of such microchannel devices, each supported within a different tube in a centrifuge. For example, each of the plural microchannel devices may have a microchannel whose shear regions are defined by different, device-specific channel geometries, such that the same sample applied to different devices is subjected to different shear forces under the same centrifugal force, yielding different fragment size ranges for the different devices.

The centrifugal force applied to the microchannel is preferably between 5,000 and 20,000 G, more preferably 10,000-16,000 G, where 1 G is the gravitational acceleration at the surface of the Earth, approximately 9.81 m/sec². The total time over which the centrifugal force is applied is preferably less than 1 minute. The sample volume added to the microchannel device may be a small as 5 and 200 μl, or less. The method may be carried out under conditions such that sample material is forced through the microchannel only when the selected centrifugal force to which the tube is subjected reaches the selected centrifugal force.

For use in fragmenting polymer molecules, the centrifugal force to which the tube is subjected may be such, in relation to the geometry of the microchannel shear regions, to fragment the polymer molecules into a desired size range under the influence of the selected force.

For use in assaying an intracellular analyte in a cell sample, movement of the cell sample through the microchannel, under the influence of a selected centrifugal force to which the tube is subjected, is effective to disrupt the cells and release intracellular contents.

For use in forming desired size lipid particles in a particle suspension, movement of the particles through the microchannel, under the influence of a selected centrifugal force to which the tube is subjected, is effective to produce the desired lipid-particle sizes. This method may be used, for example, in forming liposomes of desired size distribution or lamellar structure.

These and other objects and features of the invention will become more fully apparent when the following detailed description of the invention is read in conjunction with the accompanying drawings.

### BRIEF DESCRIPTION OF THE DRAWINGS

FIGS. 1A and 1B are sectional views of a device for fragmenting polymers constructing according to one embodiment of the invention, and shown supported within a centrifuge tube;

FIGS. 2A and 2B are top and bottom views of the device in a centrifuge, seen along view lines 2A-2A and 2B-2B in FIG. 1A, and FIG. 2C is a top view of a cap in the device;

FIGS. 3A-3C show front and side views of a device for fragmenting polymers constructed according to another embodiment of the invention (3B) and (3C); respectively, and a centrifuge tube (3A) adapted to hold the device during a fragmenting operation;

FIGS. 4A and 4B illustrate shear regions in the device of the invention, defined by different length ratios of adjacent channel segments;

FIGS. 5A and 5B illustrate shear regions in the device of the invention, defined by different channel segment geometries;

FIGS. 6A-6C illustrate other microchannel geometries effective to produce shear regions along the lengths of the microchannels;

FIG. 7 is a side sectional view of a device having a serpentine microchannel;

FIGS. 8A and 8B are enlarged sectional views of deformable-plug valve in a device in accordance with one embodiment of the invention, shown before (8A) and after (8B) release of sample into the microchannel below the valve;

FIGS. 9A and 9B are enlarged sectional views of frangible-membrane valve in a device in accordance with another embodiment of the invention, shown before (9A) and after (9B) release of sample into the microchannel below the valve;

FIG. 10 is an enlarged sectional view of an electronically controlled valve in a device in accordance with still another embodiment of the invention;

FIGS. 11A-11C are images of ethidium bromide stained agarose gels showing the distribution of DNA fragments produced by the device and method of the invention, in a device having channels segment width ratios of 100/10 microns, 100/20, and 100/40, respectively,

FIG. 11D is a bar graph showing the segment area, as a measure of fragment heterodispersity, determined from the electropherograms in FIGS. 11A-11C; and

FIG. 12 shows electropherograms showing the distribution of DNA fragments produced by the device and method of the invention, in a device having large-width and small-width channels segments of 250/20 microns, and 250-75 microns, as indicated, and where the microchannels are uncoated or coated with dicholoromethylsilane, also as indicated;

### DETAILED DESCRIPTION OF THE INVENTION

I. Definitions

The terms below have the following meanings unless indicated otherwise;

The term “channel” and “microchannel” are used interchangeably to mean a path or conduit within which a fluid sample travels.

A “microchannel” has a cross-sectional dimension, e.g., width or height or diameter, in the direction substantially perpendicular to the direction of flow in the channel, that is less than about 500 microns, typically between 5-250 microns. These dimensions may apply along the entire length of the channel, or may be confined to shear regions of the channel; that is, the microchannel dimensions may apply only within a shear region of the channel.

The term “shear region” refers a region within a channel at which a differential flow velocity of liquid flowing through the region is effective to exert of shearing force on solute or particulate material dissolved or suspended in the liquid and on the liquid itself. Where the material is an elongate polymer, e.g., a polynucleotide, the shearing force is effective to shear the polymer into smaller fragments. Where the material is a cellular material, such as mammalian or bacterial cells, the shearing force is effecting to disrupt the cell, exposing the cells' intracellular contents. Where the material is lipid particles, such as liposomes or lipid droplets in an oil-in-water emulsion, the shear force is effective to disrupt the particles such that they reform in smaller, more uniform sizes.

A “shear region” may be formed in a microchannel by any channel geometry that causes differences in liquid flow velocities at different points within that region. In one general embodiment, a shear region is formed by a change in the cross-sectional area of the flow path, typically a change in flow-channel width of at least 2:1 or 3:1 over a short channel distance. Local flow-velocity variations that can serve as shear regions can also be produced by bends or turns in the flow path, or by placing obstacles to flow in the flow path, or a combination of two of more of these geometries.

The extent of shear occurring at a shear region will depend on the local geometry at a shear region, the speed at which liquid is flowing through the region, and the orientation of material in the liquid. Implicit in the definition of a shear region is that the liquid velocity through the region is sufficient to produce a shear force that can fragment material in the liquid flowing through the region, and this in turn, requires that the centrifugal force applied to the liquid is sufficient to produce such flow velocity. Also implicit in the definition is that the cross-sectional area of the flow channel, at least in the regions of shear, is small enough to promote fragmenting shear forces at flow velocities consistent with normal centrifugation speeds.

II. Fragmentation Device

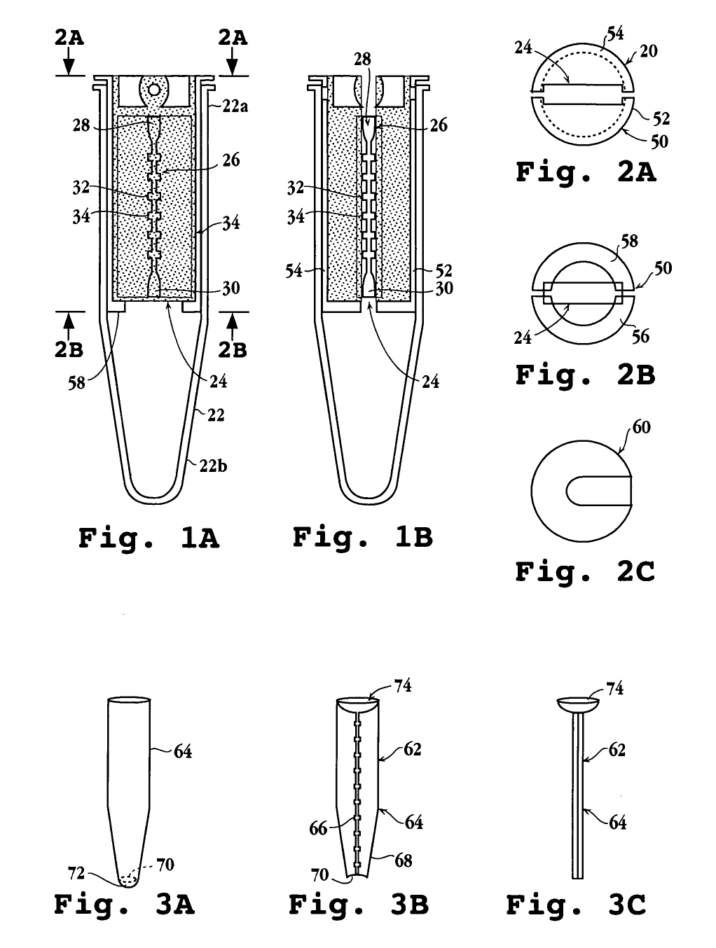

FIGS. 1A and 1B are section views of a fragmentation device 20 constructed in accordance with an embodiment of the invention and supported in a centrifuge tube 22. Tube 22 is typically a polyethylene or polypropylene microfuge tube having a total volume of 1 to 2 ml, and being capable of withstanding centrifugation forces of up to at least about 20,000 g (the gravitational force). Such tubes are available, for example, from VWR International, San Francisco, Calif., or from E&K Scientific (Campbell, Calif.) which supplies a 2 ml polypropylene screw cap microfuge tube. As shown, the tube has a generally cylindrical upper section 22a in which device 20 is supported and a tapered lower section 22b which acts to support the lower end of the device. The tube also has a lip at the top that can support the upper end of the device. In operation, sample liquid applied to device, at its upper end, is forced through the device and collected at the bottom of the tube. The tube is designed for operation with a centrifuge capable to applying a selected centrifugal force to the tube that may be as great as 27,000 G. For example, the above mentioned microfuge tube is designed for operation with a standard table-top laboratory centrifuge, such as an Eppendorf Model 5415C centrifuge, capable of speeds up to about 20,000 rpm, and a maximum centrifugal force of about 27,000 G. It will be appreciated that any type of centrifuge tube capable of supporting the fragmentation of the material at the selected G force, and any type of centrifuge capable of subjecting the tube to such G forces is suitable for the invention.

With continued reference to FIGS. 1A and 1B, device 20 includes a substrate 24 having the generally rectangular shape seen in the figures. That is, FIG. 1A shows the rectangular face of the substrate, and FIG. 1B, the substrate profile or cross-section. A microchannel 26 formed in the substrate, and extending between upper and lower channel end wells 28, 30, respectively, provides a plurality of shear regions, such as shear regions 32, 34, extending along its length. As will be detailed further below, each shear region is designed to subject material present in a sample liquid to a shearing force as sample liquid is forced through the shear region under the influence of a selected centrifugal force applied to the tube in which the device is supported. Thus, material contained in a liquid sample applied to the upper end of the microchannel, with the device supported in a centrifuge tube within a centrifuge, is fragmented by shearing as the sample is forced successively through the plurality of shear regions in the microchannel, when the selected centrifugal force applied to the tube. The microchannel preferably includes at least 5 shear regions, and typically will have 10-20 or more.

Each shear region in the microchannel has channel geometry designed to cause sharp local differences in liquid flow velocities in the liquid sample flowing through the channel. In the embodiment shown in FIGS. 1A and 1B, the shear regions are formed by alternating channel segments having different channel cross-sectional areas. FIG. 4A shows, in enlarged planar view, a portion of channel 26 containing shear regions 32, 34. Shear region 32, which is representative, is formed of an upstream channel segment 36 having a width W₂ and an adjacent downstream segment 38 having a smaller width W₁, where the direction of liquid flow in the channel is indicated by arrow 44. In this particular embodiment, the channel has a substantially rectangular cross-section along its length (in a plane perpendicular to the direction of flow in the channel) with varying channel-segment widths, as seen, and a substantially constant channel depth, on the order of W₁.

The ratio of W₂ to W₁, and therefore corresponding cross-sectional areas of segments 36, 38, is typically 2:1 or greater, e.g., 3:1 to 4:1 or larger. Typically, where the device is used for fragmenting polymers, W₁ is in the range 1-50 microns, and preferably, for use in fragment polynucleotides between about 5-20 microns. Similarly, W₂ dimensions are typically in the range 50-250 microns. Although smaller W₁ channel dimensions are possible, a nano-scale channel cross-section may lead to channel clogging and to inability to move liquid through the channel at speeds adequate to shear the material in the liquid. Similarly, although larger W₂ channel dimensions are possible, larger dimensions may inhibit the efficient processing of small volumes, e.g., in the range 1-10 μl, and may also require fluid-velocities that are impractical to achieve under normal centrifugation operation, e.g., with a standard table-top centrifuge.

Although shear regions 32, 34 described above are formed at the interface between a larger-to-smaller channel segment, it will be appreciated that the interface between a smaller-to-larger channel segments will also form a region of shear in the channel, such as region 44 at the downstream end of channel segment 38 in FIG. 4A. Other exemplary microchannel shear-region geometries will be discussed below with respect to FIGS. 4B, 5A-5B, and 6A-6C. Additionally, the substrate may be formed with more than one microchannel, where each microchannel has a plurality of shear regions, and the shear regions within a microchannel or in different microchannels of the same substrate are defined by the same or different geometries.

Substrate 24 may be formed by any of a variety of techniques suitable for preparing microchannel and/or microfluidics devices. Preferably the substrate is formed of two layers or plates that are laminated together by conventional bonding or laminating methods such as anodic bonding in the case of a Silicon substrate. The substrate may be of any suitable material, such as polymer (plastic), silicon, fused silica, or the like, and preferably, a polymer substrate. Illustrative polymers include methyl methacrylate and copolymers thereof, dimethylsiloxanes, polystyrene, and polycarbonate. Preferred polymers are PMMA (polymethylmethacrylate) and cyclic olefin homopolymer or co-polymer thermoplastics.

The microchannel formed in the substrate may vary as to dimensions, width, depth and cross-section, as well as shape, being rounded, trapezoidal, rectangular, etc. The path of the channels may be straight, angles, serpentine, or the like, consistent with the requirement of imposing a plurality of shear regions along the microchannel path. Typical channel dimensions are as given above. The channel length will range typically from one to several centimeters in length.

In a typical substrate assembly, one of two plates is prepared to include the microchannel and a second flat-surfaced plate is laminated to the plate to enclose the channel. Various surface treatment methods are available for forming the microchannel in a plate, including injecting molding, techniques involving surface-etch techniques, surface-embossing techniques, and/or microfabrication methods. The two plate may be laminated by heat-fusion, polymer adhesives, or the like, according to known methods. Manufacturing techniques also exist that allow fabrication of the channel in a single plate so that a second plate is not needed to seal the channel along its length. Any of these techniques commonly available may be used to fabricate the channel in the substrate.

Each plate forming the substrate is preferably 0.5 to 25 mm in thickness, for a total substrate thickness of between about 1-5 mm, with the constraints that the substrate is strong enough to withstand the g forces to be applied. Once the device is formed, the microchannel may be coated with a suitable lubricant or other coating material effective to improve flow properties through the microchannel and/or to reduce sticking or aggregation at the channel walls. One exemplary coating employed in some of the examples below is a silane coating, e.g., dichlorodimethylsilane. The coating may be applied simply by running a sample of the liquid coating material through the channel under centrifugal force.

In the general embodiment of the invention illustrated in FIGS. 1A and 1B, the device additionally includes a holder or adapter 50 which serves to hold the substrate securely in a centrifuge tube, such as tube 22 during operation of the device. The holder is seen in FIGS. 1A and 1B, and also in FIGS. 2A and 2B, which are top and bottom views of the device seen from view lines 2A-2A and 2B-2B, respectively in FIG. 1A. As shown, holder 50 is composed of two hemi-cylindrical members 52, 54 which embrace opposite side edges of the substrate, as seen best in FIGS. 1A and 2A, and opposite lower edge regions of the substrate, as seen in best in FIGS. 1A and 2B. Although FIGS. 2A and 2B show these members spaced apart, the members are typically forced into contact when the substrate and holder is inserted into a centrifuge tube, to support the substrate securely in the tube. An advantage of this embodiment is that a single-sized substrate may be adapted for use with any of a variety of different-sized centrifuge tubes, by providing several different adapters. Alternatively, various different sized substrates, e.g., for handling different samples, could be adapted to the same size centrifuge tube, e.g., a standard microfuge tube.

Also shown at FIG. 2C is a cap 60 that can be placed over the device to aid in loading the sample liquid in well 28 at the upper end of the substrate 24.

FIGS. 3B and 3C illustrate a fragmentation device 62 constructed in accordance with an embodiment of the invention in which the substrate and holder are formed as a single unit for placement and support within a centrifuge tube, such as tube 64 in FIG. 3A. Device 62 includes a substrate 64 having a central microchannel 66 that provides a plurality of shear regions along its length, as described above. The substrate is tapered along its lower edges 68 to engage the lower tapered sides of the centrifuge to support the device in the tube along its outer edges.

As can be appreciated from FIGS. 3B and 3A, the lower end 70 of the substrate is shaped to provide a collection zone 72 at the bottom of the tube where sample material forced through the device can be collected. A sample-receiving cup 74 formed integrally with the substrate at the upper end thereof is designed to rest against the upper lip of the centrifuge, to further support the device in the tube during operation. Alternatively, the device may be shaped as a cylindrical plug for insertion into and support within a centrifuge tube.

Although not shown, the device of the invention may further be formed to include a centrifuge tube. Here a preformed substrate, which may be in the shape of a plate or space-filling plug, is inserted into a centrifuge tube and the two secured together with a suitable binding agent. The upper end of the device may include an opening through which sample at the bottom of the tube can be accessed, e.g., by a micropipette. Alternatively, the channel containing substrate and centrifuge tube can be manufactured in a one step process, leaving a device where the substrate is integral to the centrifuge tube.

Various exemplary shear-region geometries that can be formed readily within a microchannel are illustrated in FIGS. 4B, 5A, 5B, and 6A-6C. In each case, the figure shows a portion of a microchannel in a device of the type described above, with liquid flow in a left-to-right direction as indicated by the arrow in each figure. FIG. 4B illustrates a portion of a channel 76 like that shown in FIG. 4A, except that larger-width channel segments, such as segment 78, has been lengthened (length B₂) along the direction of fluid flow relative to the length (A) of the smaller-width channels, so that the ratio of B₂:A is substantially greater than one.

Channel 82 illustrated in FIG. 5A is like channel 76, but further includes a baffle, such as baffle 88, placed in the center region of each of the larger-width channel segments, such as segment 84. The purpose of the baffles is to divert liquid flow through the channel away from the central region in each larger-width channel segment, in effect, forming additional shear regions within the channel. In addition, for elongate materials such as linear polymers carried in the liquid, the baffles may help align the molecules in the direction of greatest shear at the interface of two segments, e.g., segments 84 and 86.

FIG. 5B shows a portion of a similar type of channel 90, but including a plurality of stepped segments, such as segments 92, 96, and 98, with successively reduced widths that produce shear forces at each step down. In addition, segment 92 may include an internal baffle that creates additional shear points within the channel.

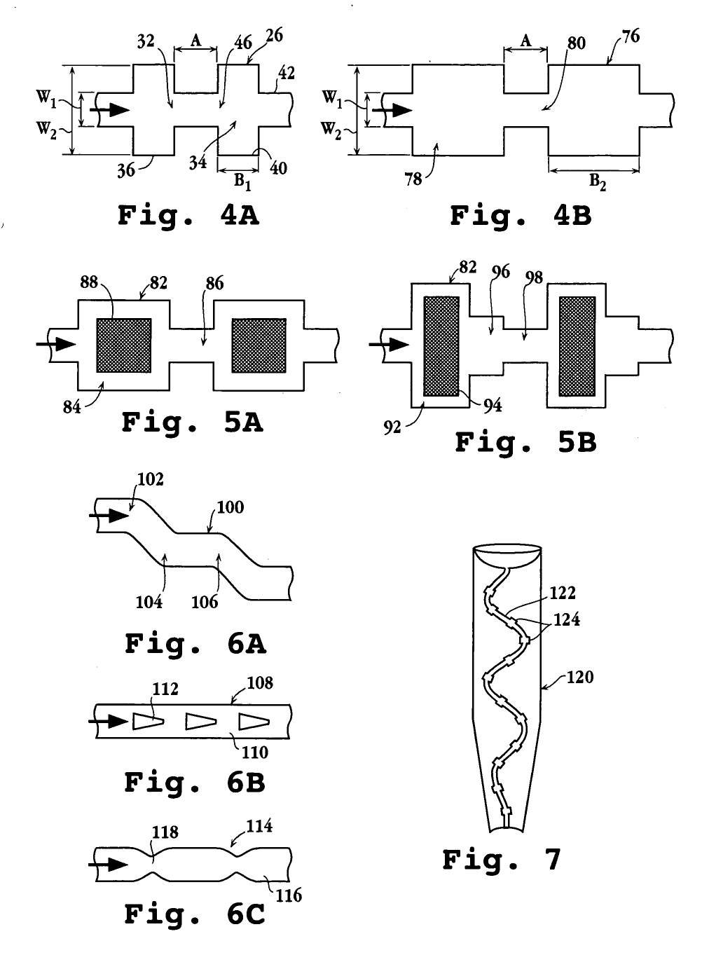

The channels described above rely on a sharp change in channel cross-sectional size for producing shear. However, shear regions within a microchannel can also be formed by abrupt changes in flow direction, as illustrated in FIG. 6A. Here channel 100 has a relatively constant-width flow path 102 with a series of changes in flow direction such as at 104,106 where shear flow is induced.

In the channel 108 in FIG. 6B, shear flow is produced at each of a plurality of baffles, such as baffle 112, placed along a straight flow-path 110 whose outer dimensions are constant along its length. A similar type of channel is channel is seen at 114 in FIG. 6C, where shear regions are produced by a series of smoothly-curved constrictions, such as 118, in the flow path 116.

Finally, FIG. 7 shows a device 120 having a serpentine microchannel 122 with a plurality of shear regions, such as at 124, located along its length. As can be appreciated, the serpentine channel can accommodate more shear regions along its length, e.g., 10-20 or more regions, compared with a straight channel.

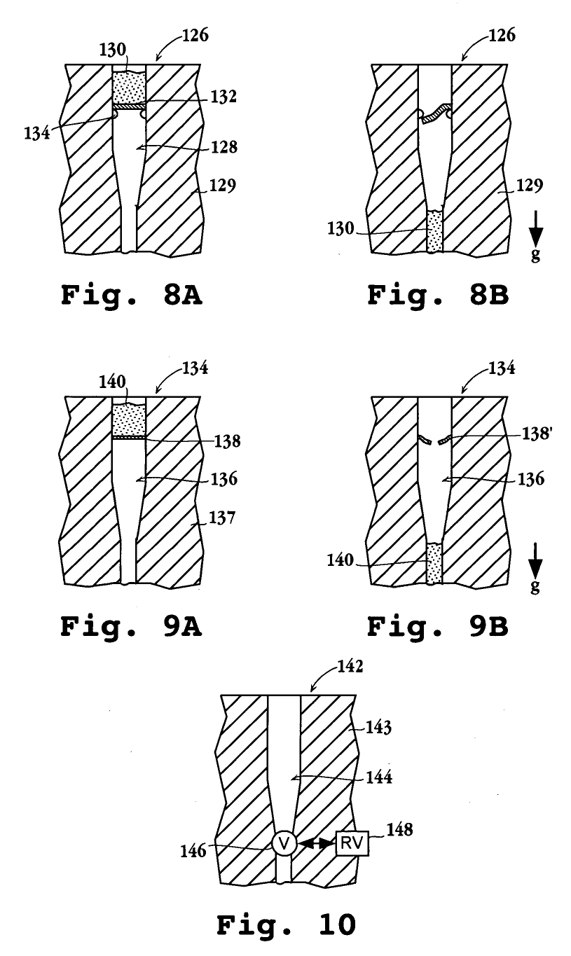

As noted above, the shear force created at each shear region along the length of a microchannel will depend on channel geometry and the speed of liquid being forced through the microchannel under centrifugal force. In order to insure that liquid sample flowing through the microchannel is at a desired flow velocity, and/or at a substantially uniform velocity in each flow region, it may be desirable to restrict sample flow through the microchannel until a selected centrifugal force (centrifuge speed), e.g., 5000-15,000 G is reached. This can be done, in accordance with various embodiments of the invention shown in FIGS. 8-10, which illustrate various valving mechanisms located at the sample input region of a fragmentation device, just upstream of the microchannel in the device.

Device 126 shown in FIGS. 8A and 8B includes a substrate 129 having a sample inlet well 128 communicating at its lower end with the upper end of smaller-width microchannel. A pair of detents, such as at 134 formed in the wall of chamber 128, support a deformable plug 132 which is initially tightly fitted in the chamber against the detents as shown, forming a fluid seal at the site of the plug. Thus sample liquid 130 placed in the chamber is initially confined to the chamber region above the plug. The plug is so formed, in relation to the dimensions of the detents, that it will deform and break its seal at a selected g force, as indicated at FIG. 8B, allowing sample liquid 130 to enter the upper end of the microchannel when the selected g force is reached.

Device 134 shown in FIGS. 9A and 9B has a similar construction of a substrate 137 with a sample-receiving well 136 formed therein, communicating with the upper end of a smaller-width microchannel, except that the sample barrier in this embodiment is a frangible seal 138 formed within the chamber. The frangible seal is typically a thin polymer membrane constructed to break when a volume of sample liquid 140 is forced against the seal under a selected g force, resulting in release of sample into the microchannel as shown in FIG. 9b.

Device 142 shown in FIG. 10 has a similar construction, but where the lower end of a sample sample-receiving well 144 in substrate 143 communicates with the microchannel through an electronically controlled valve 146. An electronic receiving unit 148 in the device is designed to move the valve from its closed to its open condition, when activated by an external signal sent to unit 148, at a selected centrifuge speed.

Although not shown here, the invention also includes a plurality of devices of the type described above, where each device may include different geometry shear-regions, such that a selected substrate can produce a desired type of fragmentation, e.g., polymer fragment size range, that is distinctive for that substrate. This allows the user to select a desired fragmentation outcome, e.g., fragment size range, or to achieve each of a plurality of different outcomes, preferably in a multiplexed operation, that is, where several samples are being processed at the same time; e.g. in different tubes in the same or multiple centrifuges.

III. Fragmentation Method

In the method of the invention, a sample material contained in a liquid solution or suspension is fragmented by applying the sample solution to an upstream region of a microchannel device defining a plurality of channel shear regions, and with the device supported in a centrifuge tube, subjecting the tube to a centrifugal force sufficient to cause liquid shear forces that fragment the material by shearing as the sample is forced successively through the shear regions of the microchannel.

The material to be fragmented may be linear or branched polymers. A polymer of particular interest is large polynucleotides, e.g., chromosomal or naked DNA obtained from biological samples. Such polynucleotide strands can have base-number sizes of a million or more, and it is often desired, for purposes of DNA cloning, sequencing, or other analysis to fragment the polynucleotide material into fragments within a desired size range, e.g., 10-20 kbases, or into different groups of desired sizes, e.g., 5-10 kbases, 8-15 kbases, 10-20 kbases, etc. The example below details DNA fragmentation results obtained in microchannels whose shear regions are formed by different, selected channel widths.

Another exemplary polymer is polyethylene glycol where it is desired to reduce the size heterogeneity of a population of polymer molecules to a desired size range, e.g., 3-5 kdalton molecular weight, for purposes of creating a more uniform size distribution of the polymers. In general, any large-molecule weight and/or polymer with size heterodispersity may be a candidate for fragmentation into smaller sizes and in a more uniform size range.

Another material suitable for fragmentation in the method are biological cells, preferably in individual cell suspension, such as a suspension of bacterial cells, or cultured mammalian or plant cells, or subcellular fractions, such a mitochochondria, nuclei, or chloroplasts. Here the purpose of the method is to disrupt cells and release subcellular and/or sub-particulate material, for purposes of analyzing or isolating one or more intracellular components. As an example, the method may be used to analyze small cellular fraction, e.g., in 1-10 μl volume. If the sample material to be analyzed is intracellular DNA, the method provides the advantage of being able to disrupt cells and nuclei, and fragment release DNA all in a single fragmentation step that may involve an extremely small or dilute cell fraction.

Another material to be fragmented, in accordance with the invention, are lipidic particles, including micelles, liposomes, triglyceride particles, lipid-in water emulsion particles, and lipoprotein particles, such as high density lipoprotein particles, obtained from a blood sample. In one embodiment, liposomes having a heterodisperse size range, e.g., 0.10 to 20 microns, are fragmented into smaller, more uniform particles sizes, e.g., liposomes having sizes in the 0.05 to 0.2 micron size range, and/or having single or few lipid lamellae.

In one general embodiment, the method is used for simultaneous processing of multiple samples, one fragmentation device for each of the up to 8 or more tube slots in a centrifuge. The method may be applied to multiple samples, each processed in an identical fragmentation device, or may be applied to a single sample, e.g., DNA sample, fragmented in different devices designed to produce different fragment size ranges at the same centrifugal force, as described above.

The centrifugal force that is applied in the method is selected to produce a desired shear force at the shear regions in the microchannel device. Typical selected centrifugal forces are between 5000 and 20,000 G, e.g., 10,000-16,000 G-. The g force applied is readily determined, for a given centrifuge, by a speed-g force conversion table provided for centrifugation instruments. In the table-top centrifuge noted above, speeds of up to 20,000 rpm are effective to produce centrifugal forces of up to about 27,000 G. As can be appreciated, the high g forces achievable in the invention are much higher than those that can be achieved by conventional pump or syringe techniques, and this contributes to both shearing efficiency and speed.

The centrifugation time may be virtually instantaneous, i.e., a few seconds, once the centrifuge as reached the desired speed, or may be up to several minutes, e.g., 30 minutes, particular where very small channel dimensions are employed. Preferred centrifugation times are less than 1 minutes, since the higher liquid velocities associated with shorter transit times contribute to higher shear forces. Multiple microchannels in a substrate can be used to reduce the centrifugation time compared to centrifugation time when using a substrate with only one microchannel. As noted above, the sample material may be released into the microchannel by suitable valving mechanisms only when the centrifuge has reached a desired rpm.

In accordance with another feature of the invention, sample, volumes may be quite small, since (i) the microchannels themselves have a low total volume, (ii) virtually all of the sample liquid is driven through the microchannel and into the bottom of the tube, leaving little or no sample residue, (iii) transit times are short so evaporation effects are minimized, there is no reprocessing of the sample, since the sample is fragmented multiple times as it is forced through the microchannel. Sample volumes may be in the nanoliter range, and typically sample volume added to the microchannel device is between 5 and 200 μl (micro-liters).

Finally, the method may be easily automated, for example, where an autosampler is used to inject samples into centrifuge tubes and to extract processed samples containing DNA fragments from centrifuge tubes. The shearing process may also be computer controlled to select run parameters such as centrifuge rotational speed and duration, and to select a shearing device of a given geometry.

From the foregoing, it can be seen how various objects and features of the invention are met. The system is capable of multiple processing of a sample in a single rapid centrifugation run, avoiding the time, expense and material loss associated with multiply processing a sample. Further, multiple sample can be processed under identical g-force conditions, allowing several samples to be processed simultaneously, or a single sample to be processed under different shear conditions. The method is amenable to small sample volumes, and provides efficient recovery of processed sample material. Finally, the method can be practiced with very little additional expense, assuming that a centrifuge and tubes are already available on site.

The following example illustrates the application of the invention to DNA shearing, for purposes of obtaining DNA fragments of a more uniform size distribution.

DNA was extracted from mouse genomic DNA, and brought to a final concentration of 10 ng/μl. Substrates having rectangular microchannel segments of different selected-size widths were prepared as described above. The substrates have 10 shear regions, and one of the following segment-widths ratios:

Substrate (A) 250 μm wide channel segment:20 μm narrow channel segment (250:20).

Substrate B: 250:75

Substrate C: 100:10

Substrate D: 100:20

Substrate E: 100-40.

Sample runs were carried out in 2 ml polypropylene microfuge tubes, employing an Eppendorf Model 5415C centrifuge. Each substrate was washed with 100 micro-liter 95% ethanol, followed by 100 μl distilled water. Where indicated, the substrate microchannels were coated by running 20 μl dichlorodimethylsilane through the wafer. After channel coating, the substrate was soaked for 1 week in 2 ml water (water was changed 3 times over the week), then washed 5 times with water, to remove all residues.

Sample of DNA, 70 μl were applied to the substrates and fragmented by running each sample at 15,000 rpm, corresponding to approximately 15,000 G, for 10 seconds, following an 8-second period needed to reach maximum speed. The samples were passed through the device under similar conditions 0 to eight times. Sample aliquots (5 μl) were applied to standard acrylamide gel slabs and fractionated by electrophoresis under standard conditions. The resulting fragment patterns were photographed under UV light in the presence of ethidium bromide.

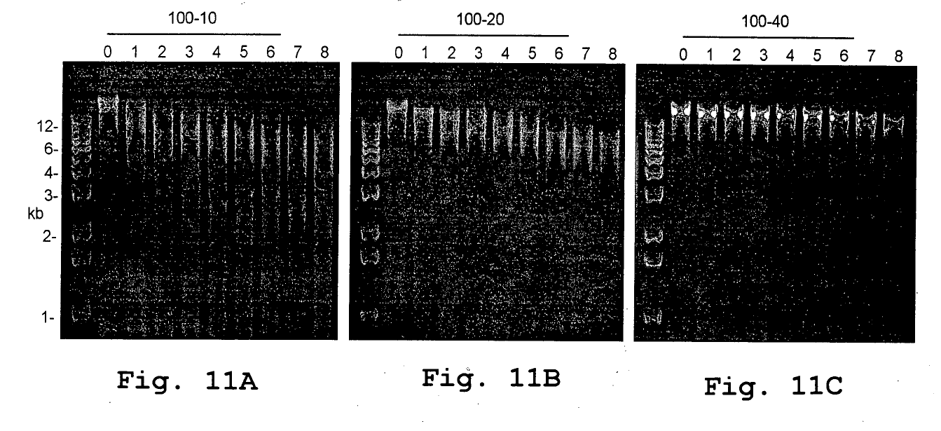

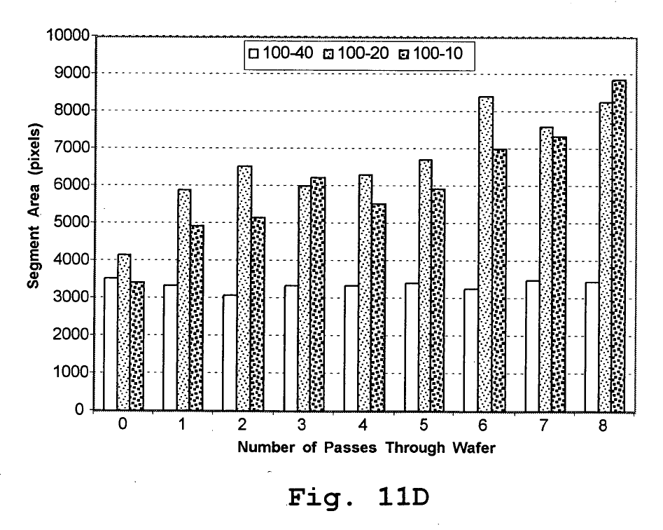

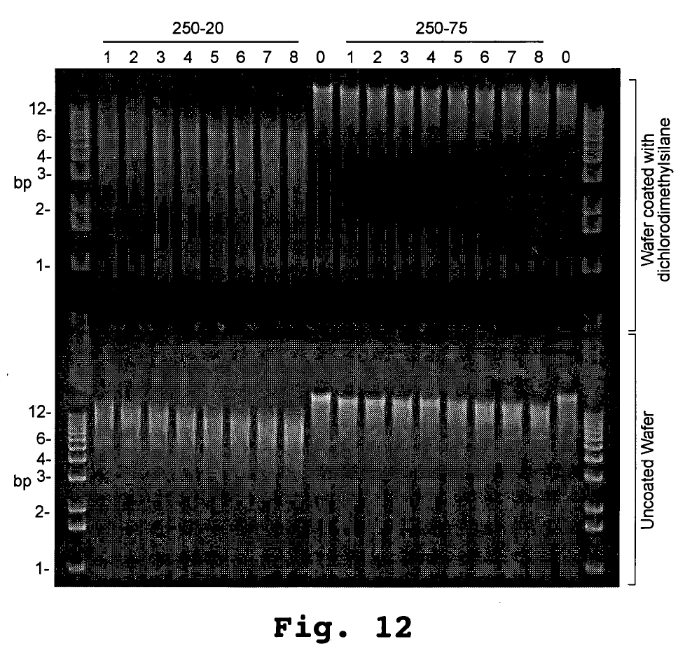

FIGS. 11A shows gel patterns for samples after fragmentation in devices containing either 100:10,100:20, or 100:40 channel segment widths, processed from 0 to eight times, as indicated in the figure. The migration positions of standard DNA fragment sizes between 1 and 12 kbase is shown at the left in the figure. The gels were scanned and analyzed to determine a distribution of fragment sizes, expressed as segment area in FIG. 11B. As seen in that figure, a single processing through 100:20 or 100:10 produced significant fragmentation. The 100:20 device appears to produce greater fragmentation than the 100:10 device, except this difference was erased by the eight pass through the device. It will be recognized that, although increased fragmentation was achieved with multiple passes through the device, the same effect could be achieved by employing a device with more shear regions, e.g., 50-60 shear regions instead of the ten present in the device employed.

FIG. 12 shows the results of similar DNA fragmentation method, except where the two devices employed had 250:20 and 250:75 channel-segment widths, and both silanized and uncoated microchannel devices were tested. As seen from the electropherograms, the 250-20 devices yield a lower fragment size than the 250:75 for both coated and uncoated microchannels.

Although the invention has been described with respect to particular geometries and applications, it will be apparent that various changes and modification may be made without departing from the invention.

It is claimed:

1. A device for use with a centrifuge for fragmenting solute or particulate material contained in a liquid sample, said device comprising
a substrate adapted to be supported within a centrifuge tube,
formed in said substrate, a microchannel extending between upper and lower channel ends and defining a plurality of shear regions, each designed to subject material present in the sample liquid to a shearing force as sample liquid is forced through the shear region under the influence of a selected centrifugal force applied to the tube in which the device is supported,
wherein material contained in a liquid sample applied to the upper end of the microchannel, with the device supported in a centrifuge tube within a centrifuge, is fragmented by shearing as the sample is forced successively through the plurality of shear regions in the microchannel, when the selected centrifugal force applied to the tube.

2. The device of claim 1, which further includes a holder adapted to be received within a selected-size centrifuge tube, and adapted to support said substrate within the tube.

3. The device of claim 1, wherein said substrate includes support members constructed to support the substrate within a selected-size centrifuge tube.

4. The device of claim 1, which is formed as an integral unit with a centrifuge tube.

5. The device of claim 1, wherein the microchannel includes at least 5 shear regions.

6. The device of claim 1, wherein the microchannel has a serpentine shape.

7. The device of claim 1, wherein said device includes a sample-receiving well and a fluid-flow barrier interposed between the well and the microchannel, for preventing liquid sample applied to the well from reaching the upper end of the microchannel until a selected centrifugal force is applied to the device.

8. The device of claim 7, wherein said barrier includes deformable members which remain interlocked at a channel-sealing condition until deformed under the selected centrifugal force.

9. The device of claim 7, wherein said barrier includes a frangible seal designed to fracture when a liquid sample is forced against the seal under the selected centrifugal force.

10. The device of claim 7, wherein said barrier includes an electronically controlled valve which can be externally activated, from a closed to an open condition, when an external signal is applied to the valve.

11. The device of claim 1, wherein shear regions in the microchannel are defined by a change in the cross-sectional area of the channel, in a direction substantially perpendicular to the direction of fluid flow in the channel.

12. The device of claim 11, wherein a shear region is defined by adjacent upstream and downstream channel segments having a ratio of cross-sectional areas of at least 3:1.

13. The device of claim 12, wherein said upstream channel segment includes a central baffle which acts to prevent liquid flow through a central portion of that channel segment.

14. The device of claim 12, for use in fragmenting polynucleotide molecules, wherein the downstream segment in a microchannel has a width dimension of less than 20 microns.

15. The device of claim 1, wherein shear regions in the microchannel are defined by changes in the direction of liquid flow in the microchannel.

16. The device of claim 1, wherein shear regions in the microchannel are defined by physical barriers placed in the path of liquid flow in the microchannel.

17. The device of claim 1, wherein the substrate includes a plurality of different microchannels, each defining a plurality of shear regions along their lengths.

18. A polymer-fragmentation kit designed for use with a centrifuge for fragmenting a sample solution of polymers, such as polynucleotides, into a plurality of polymer-fragment pools, each with a different fragment-size range, comprising
a plurality of fragmentation devices, each device comprising
(i) a substrate adapted to be supported within a centrifuge tube,
(ii) formed in said substrate, a microchannel extending between upper and lower channel ends and defining a plurality of shear regions, where the shear regions in each device have a device-specific shear-region geometry designed to subject material present in the sample solution of polymers to a device-specific shearing force as sample solution is forced through the shear region under the influence of a selected centrifugal force applied to the tube in which the device is supported,
wherein polymers contained in a liquid sample applied to the upper ends of different devices in the kit, with the devices supported in centrifuge tubes within a centrifuge, are fragmented by shearing as the samples are forced successively through the plurality of shear regions in each device, to produce polymer fragments having different size ranges.

19. The kit of claim 18, wherein one or more of the devices includes a substrate having a plurality of different microchannels, each microchannel defining a plurality of shear regions along their lengths.

20. A method for use with a centrifuge for fragmenting solute or particulate material contained in a liquid sample, said method comprising
applying the sample solution to an upstream region of a microchannel device having a microchannel defining a plurality of shear regions, and
with the microchannel device supported within a centrifuge tube in the centrifuge, subjecting the tube to the selected centrifugal force, wherein sample material is fragmented by shearing as the sample is forced successively through the plurality of shear regions in the microchannel.

21. The method of claim 20, for processing a plurality of samples at the same time, wherein said applying includes applying one or more sample solutions to each of a plurality of such microchannel devices, each supported within a different tube in a centrifuge.

22. The method of claim 21, wherein each of the plural microchannel devices has a microchannel whose shear regions are defined by different, device-specific channel geometries, such that the same sample applied to different devices is subjected to different shear forces under the same centrifugal force.

23. The method of claim 20, wherein the centrifugal force to which the microchannel device is subjected is between 5000 and 27,000 G.

24. The method of claim 23, wherein the centrifugal force to which the microchannel device is subjected is between 10,000-16,000 G.

25. The method of claim 23 or claim 24, wherein the total time over which the centrifugal force is applied is less than 1 minute.

26. The method of claim 18, wherein the sample volume added to the microchannel device is between 5 and 200 μl.

27. The method of claim 20, wherein sample material is forced through said microchannel only when the selected centrifugal force to which the tube is subjected reaches the selected centrifugal force.

28. The method of claim 20, for use in fragmenting polymer molecules, wherein the centrifugal force to which the tube is subjected is such, in relation to the geometry of the microchannel shear regions, to cause shear forces that fragment the polymer molecules into the desired size range under the influence of the selected force.

29. The method of claim 20, for use in assaying an intracellular analyte in a cell sample, wherein movement of the cell sample through the microchannel, under the influence of a selected centrifugal force to which the tube is subjected, is effective to disrupt the cells and release intracellular contents.

30. The method of claim 20, for use in forming desired size lipid particles in a particle suspension, wherein movement of the particles through the microchannel, under the influence of a selected centrifugal force to which the tube is subjected, is effective to produce the desired lipid-particle sizes.

31. The method of claim 30, wherein the lipid particles comprises liposomes and the method is used to produce liposomes of desired size distribution or lamellar structure.

32. The method of claim 18, for use in study of DNA replication, repair, and transcription, wherein DNA is randomly fragmented to produce short functionally distinct segments that are used in the study of binding and binding conditions of compounds that interact with DNA.
